(19) United States
(12) Patent Application Publication
(10) Pub. No.: US 2024/0213636 A1
(43) Pub. Date: Jun. 27, 2024

(54) CIRCUMFERENTIALLY CONTINUOUS, AXIALLY AND RADIALLY STRETCHABLE, FIRE SUPPRESSING, PUNCTURE RESISTANT, DIELECTRIC KNIT SLEEVE

(71) Applicant: FEDERAL-MOGUL POWERTRAIN LLC, Northville, MI (US)

(72) Inventors: Xiaodan Qiu, Phoenixville, PA (US); Scott Ian McFarland, Maumelle, AR (US); Yuki Yoneshige, Machida (JP); Kamel Fennell, Plymouth Meeting, PA (US)

(21) Appl. No.: 18/391,650

(22) Filed: Dec. 20, 2023

Related U.S. Application Data
(60) Provisional application No. 63/434,539, filed on Dec. 22, 2022.

(51) Int. Cl. H01M 50/591; D06M 15/643

(52) U.S. Cl. CPC H01M 50/591; D06M 15/643; D10B 2101/02; D10B 2403/0112; D10B 2403/033; H01M 2220/20

(57) ABSTRACT

A sleeve for providing protection to a bus bar interconnecting cells of a battery of an electric vehicle has a knit wall having a circumferentially continuous outer surface extending along a longitudinal axis between opposite open ends. The knit wall is formed by multifilament flame-resistant yarn having a denier between 30 tex to 420 tex. An impervious coating extends about the entirety of an outer surface of the knit wall.

### CROSS-REFERENCE TO RELATED APPLICATIONS

This application claims the benefit of U.S. Provisional Application Ser. No. 63/434,539, filed Dec. 22, 2022, which is incorporated herein by reference in its entirety.

### BACKGROUND OF THE INVENTION

### 1. Technical Field

This invention relates generally to knit sleeves for protecting an elongate member contained therein, and more particularly to circumferentially continuous, axially and radially stretchable, fire suppressing, puncture resistant, dielectric knit sleeves.

### 2. Related Art

It is known to contain elongate members, such as wires, wire harnesses, cables and conduits of various types in circumferentially continuous, tubular walled sleeves to provide protection to the elongate members against impact and abrasion, fluid and external thermal affects. However, there remains a need for protective sleeving that can provide dielectric, fire suppressant, puncture resistant protection to an elongate member contained therein, while also being able to attain a low profile, having a conformed fit about the elongate member and connectors thereof so as to not be cumbersome, unsightly and bulky. There is a further need to have a protective sleeve that is able to protect a bus bar connection between cells of a battery pack of an electric vehicle battery system to enable the vehicle to remain drivable under power from the battery system for at least 5 minutes after a thermal runaway condition of one or more of the cells of the battery to enable a driver of the electric vehicle ample time to safely maneuver to a suitable parking location and vacate the vehicle.

### SUMMARY OF THE INVENTION

One object of the disclosure is to provide a stretchable knit sleeve that provides dielectric, fire suppressant protection to an elongate member contained therein.

Another object of the disclosure is to provide protection to a bus bar connection between cells of a battery pack of an electric vehicle battery system to enable a driver of the electric vehicle ample time to safely maneuver to a suitable parking location and vacate the vehicle.

Another object of the disclosure is to provide protection to a bus bar connection between cells of a battery pack of an electric vehicle battery system via a knit sleeve to enable the battery system to supply power to the electric vehicle for 5 minutes or more after a cell experiences a thermal runaway condition.

Another object of the disclosure is to provide a protective member that is easy to dispose about a bus bar connection and connectors between cells of a battery pack of an electric vehicle battery system.

Another object of the disclosure is to provide a knit sleeve that is able to conform about a bus bar connection between cells of a battery pack of an electric vehicle battery system in snug fitting relation about the bus bar and any connector attached thereto.

Another object of the disclosure is to provide a knit sleeve that is able to conform about a bus bar connection between cells of a battery pack of an electric vehicle battery system and to withstand rupture or tearing upon being impacted by an external impact force.

In accordance these and other objects, a sleeve for providing protection to a bus bar interconnecting cells of a battery of an electric vehicle is provided. The sleeve has a knit wall having a circumferentially continuous outer surface extending along a longitudinal axis between opposite open ends. The knit wall is formed at least in part by multifilament flame-resistant yarn having a denier between 30 tex to 420 tex. The knit structure of the knit wall is stretchable axially and radially, thereby allowing the knit wall easily to flex and be easily assembled into close conforming, wrinkle-free relation about the bus bar regardless of the number of bends and shape of the outer contour of an outer surface of the bus bar. An impervious coating is provided to extend about the outer surface of the knit wall to prevent the ingress and penetration of electric dust, particles, smoke through the knit wall, and to enhance the flame resistance and flame protection of the sleeve.

In accordance with another aspect of the invention, the knit wall is formed entirely with multifilament flame-resistant yarn having a denier between 30 tex to 420 tex.

In accordance with another aspect of the invention, the knit wall is formed entirely with multifilament flame-resistant yarn having a denier between 100 tex and 180 tex.

In accordance with another aspect of the invention, the knit wall is formed entirely with multifilament flame-resistant yarn having a denier between 120 tex and 160 tex.

In accordance with another aspect of the invention, the impervious coating is elastomeric and stretchable to allow the underlying knit wall to remain stretchable, thereby facilitating the formation of a wrinkle-free, snug conforming fit of the knit wall about the bus-bar.

In accordance with another aspect of the invention, the impervious coating is one of a silicone-based, pure silicone, liquid silicone rubber, polytetrafluoroethylene, or polyurethane layer bonded directly to the outer surface of the knit wall.

In accordance with another aspect of the invention, the impervious coating has a thickness between about 0.05 mm and 4.0 mm, and preferably between about 0.05 mm and 1.0 mm, and more preferably between about 0.05 mm and 0.3 mm.

In accordance with another aspect of the invention, the multifilament flame-resistant yarn extends in a lengthwise direction generally parallel to the longitudinal axis and in a circumferential weft direction about the longitudinal axis.

In accordance with another aspect of the invention, the flame-resistant yarn is a mineral yarn.

In accordance with another aspect of the invention, the mineral yarn can be provided as at least one of fiberglass, silica, and basalt.

In accordance with another aspect of the invention, the knit wall can be knit with a rib-knit pattern, having raised ribs extending in at least one of a lengthwise warp direction and/or a circumferential weft (fill) direction, with the ribs enhancing flexibility, conformability and stretchability.

In accordance with another aspect of the invention, the rib-knit pattern can be formed by alternating knit and purl stitches in a 1×1 pattern or 2×2 pattern.

In accordance with another aspect of the invention, the knit stitches are sized having between 4 to 20 stitches per 2 cm, and more preferably between 10 to 17 stitches per 2 cm in the course direction and between 4 to 22 stitches per 2 cm, and more preferably between 9 to 15 stitches per 2 cm in the wale direction.

In accordance with another aspect of the invention, the rib-knit pattern can include slip stitches to increase the height of the ribs(s).

In accordance with another aspect of the invention, a sleeve for protecting a bus bar connection between cells of a battery pack of an electric vehicle is provided. The sleeve consists of: a tubular knit wall having a circumferentially continuous outer surface extending along a longitudinal axis between opposite open ends. The knit wall is formed of flame-resistant multifilament yarn having a denier between 30 tex to 420 tex, with an outermost impervious coating that is stretchable to allow the underlying knit wall to remain stretchable, thereby facilitating the formation of a wrinkle-free, snugly conforming fit of the knit wall about the bus-bar.

In accordance with another aspect of the invention, the knit wall consists of multifilament flame-resistant yarn having a denier between 100 tex to 180 tex.

In accordance with another aspect of the invention, the knit wall consists of multifilament flame-resistant yarn having a denier between 120 tex to 160 tex.

In accordance with another aspect of the invention, the multifilament flame-resistant yarn consists of a knit stitch having a stitch size between 4 to 20 stitches per 2 cm in a circumferentially extending course direction and between 4 to 22 stitches per 2 cm in a lengthwise extending wale direction.

In accordance with another aspect of the invention, the multifilament flame-resistant yarn consists of a knit stitch having a stitch size between 10 to 17 stitches per 2 cm in a circumferentially extending course direction and between 9 to 15 stitches per 2 cm in a lengthwise extending wale direction.

In accordance with another aspect of the invention, the impervious, elastomeric coating consists of a silicone-based coating.

In accordance with another aspect of the invention, a method of constructing a sleeve for providing dielectric protection to a bus bar interconnecting batteries of an electric vehicle is provided. The method includes knitting multifilament flame-resistant yarn having a denier between 30 tex to 420 tex to form a wall having a circumferentially continuous outer surface extending along a longitudinal axis between opposite open ends and forming an impervious coating on an outer surface of the knit wall, with the impervious coating being stretchable to allow the underlying knit wall to remain stretchable, thereby facilitating the formation of a wrinkle-free, snug conforming fit of the knit wall about the bus-bar.

In accordance with another aspect of the invention, the method includes knitting the wall entirely with multifilament flame-resistant yarn having a denier between 100 tex and 180 tex.

In accordance with another aspect of the invention, the method includes knitting the wall entirely with multifilament flame-resistant yarn having a denier between 120 tex and 160 tex.

In accordance with another aspect of the invention, the method further includes knitting the stitch size having between 4 to 20 stitches per 2 cm, and more preferably between 10 to 17 stitches per 2 cm in the course direction and between 4 to 22 stitches per 2 cm, and more preferably between 9 to 15 stitches per 2 cm in the wale direction.

In accordance with another aspect of the invention, the method further includes bonding an impervious, elastically stretchable coating to the outer surface of the knit wall.

In accordance with another aspect of the invention, the method further includes bonding an impervious, elastically stretchable coating having a uniform thickness over the entirety of the knit wall.

In accordance with another aspect of the invention, the method further includes forming the impervious, elastically stretchable coating from one of an silicone, silicone-based, liquid silicone rubber, polytetrafluoroethylene, or polyurethane layer.

In accordance with another aspect of the invention, the method can further include providing the multifilament flame-resistant yarn from at least one of fiberglass, silica, and basalt.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of a motor vehicle having one or more knit sleeves constructed in accordance with one aspect of the disclosure disposed about an electric vehicle battery member to be protected;

FIG. 2A is an enlarged, fragmentary schematic perspective view of a knit sleeve constructed in accordance with an embodiment of the disclosure shown disposed about the elongate member to be protected with the textile sleeve;

FIG. 2B is a view similar to FIG. 2A illustrating a sleeve constructed in accordance with another embodiment of the disclosure shown disposed about an elongate member to be protected;

FIG. 2C is a view similar to FIG. 2B illustrating a sleeve constructed in accordance with another embodiment of the disclosure shown disposed about an elongate member to be protected;

FIG. 3 is an enlarged schematic cross-sectional view taken generally along the line 3-3 of FIG. 2A; and

FIG. 4 is a fragmentary view of a wall of a sleeve constructed in accordance with an aspect of the disclosure illustrating knit stitches thereof.

### DETAILED DESCRIPTION OF PREFERRED EMBODIMENTS

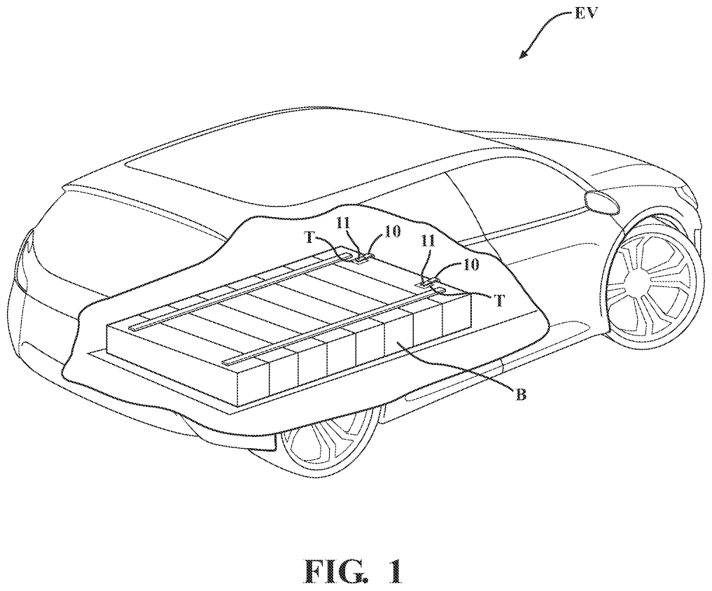

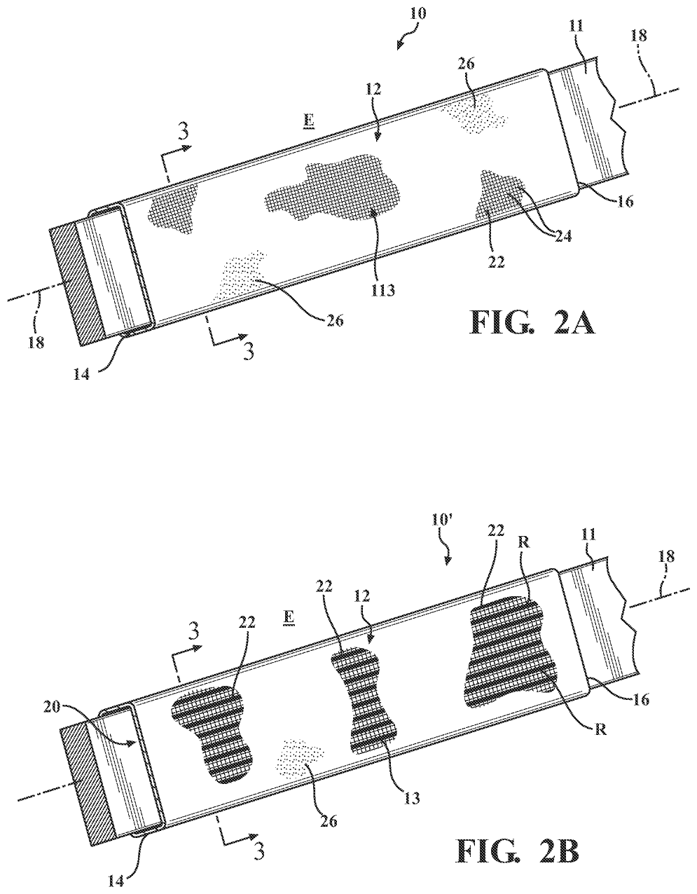

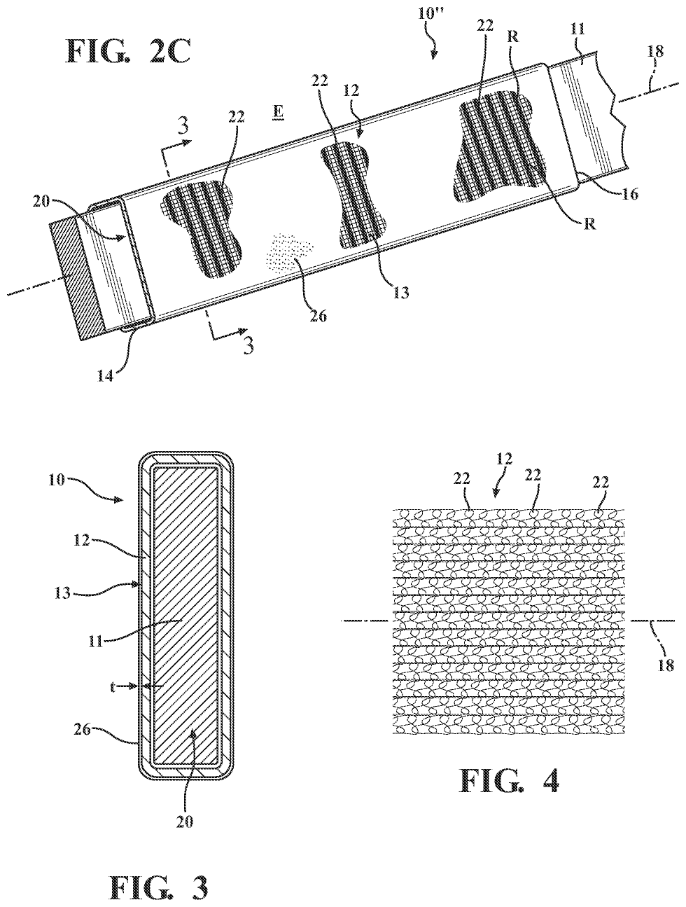

Referring in more detail to the drawings, FIGS. 2A and 3 illustrate a textile sleeve, referred to hereafter as sleeve 10, constructed in accordance with one aspect of the invention having a stretchy textile knit wall 12 disposed about an elongate member 11 to be protected, such as a bus bar interconnecting adjacent cells of a battery pack B (FIG. 1) of a vehicle, such as an electric vehicle EV, to one another. The knit wall 12 has a circumferentially continuous outer surface 13 that extends lengthwise between open opposite ends 14, 16 and about a longitudinal central axis 18 to bound a central cavity 20, through which the elongate member 11 extends. The elongate member 11 is protected in the central cavity 20 against impact forces, such as may be experienced in a vehicle crash, abrasion, and ingress of contamination, by way of example and without limitation. The wall 12 suppresses flame propagation, such as in the event of thermal runaway of one or more of the cells of the battery pack B, thereby allowing the electric vehicle EV to remain powered by the battery for at least 5 minutes or more to allow the electric vehicle EV to be safely driven to a parked location, whereat the operator can evacuate the electric vehicle EV. The flexible knit wall 12 is formed at least in part, or entirely of flame-resistant, impact resistant multifilament yarn 22 (FIG. 3) knit having a denier between 30 tex to 420 tex. The knit wall 12 in FIG. 2A is shown as having generally smooth inner and outer surface along the length of the sleeve 10, and can be formed of any stretchy knit stitches, such as produced via jersey knit stitches (FIG. 4) or tricot knit stitches, by way of example and without limitation.

In accordance with a further aspect, the multifilament yarn 22 of a sleeve 10′, 10″ constructed in accordance with an aspect of the disclosure can be knit using a rib-stitch pattern to enhance stretchability of the wall 12 to facilitate the ease of assembly of the sleeve 10 about the elongate member 11 and any connectors thereon. A plurality of ribs (R) are formed via alternating knit and purl stitches with one another in a 1×1 or 2×2 knit stitch pattern to form lengthwise extending (warp direction) ribs R (sleeve 10′ shown in FIG. 2B) and/or circumferentially extending (weft or fill) ribs R (sleeve 10″ shown in FIG. 2C) to facilitating the formation of a wrinkle-free, snug conforming fit of the knit wall 12 about the bus-bar 11, thereby facilitating assembly and the suppression of flame.

Regardless of the knit stitch type used to constructed the wall 12, the wall 12 is knit having a non-bulky low profile, and thus, is aesthetically appealing. The knit wall 12 can be knit via a weft knitting process, a warp kitting process, a flatbed knitting machine, or a circular knitting machine. Regardless, the knit structure of the knit wall 12 is stretchable axially and radially, thereby allowing the knit wall easily to flex and be easily assembled into close, snug fitting relation about the bus-bar 11 and any connectors thereon.

To further enhance the flame, impact, puncture/tear resistance, and resilience of the sleeve 10, 10′, 10″, a tough, impervious, elastomeric coating 26 is provided to extend about the outer surface 13 of the knit wall 12. The coating 26 further prevents the ingress and penetration of dust, particles, smoke through the knit wall 12. The impervious coating 26 is elastically stretchable in all directions, including the lengthwise and radial directions, to allow the underlying knit wall 12 to remain stretchable along the lengthwise and radial directions, and elastically resilient, thereby facilitating the formation of a wrinkle-free, snug conforming fit of the knit wall 12, and ultimately the sleeve 10, about the bus-bar 11 and any connectors thereon.

Upon being exposed to an extreme heat scenario, such as during an unintended thermal runaway condition within a cell of the battery pack B, the flame-resistant multifilament yarn 22 retain their structural integrity to suppress flame growth and propagation for at least 5 minutes or more, thereby allowing ample time for an occupant of the motor vehicle EV to park and/or evacuate the motor vehicle EV. The wall 12, in accordance with a further aspect, can be knit with the flame-resistant multifilament yarn 22 provided having a denier between 100 tex to 180 tex, and in one exemplary embodiment, knit entirely with the flame-resistant multifilament yarn 22 having a denier between 100 tex to 180 tex, and in another exemplary embodiment, knit entirely with the flame-resistant multifilament yarn 22 having a denier between 120 tex and 160 tex. To optimize the ability of the wall 12 to suppress flame propagation for 5 minutes or more, it has been found that the stitch size the design has between 4 to 20 stitches per 2 cm, and more preferably between 10 to 17 stitches per 2 cm in a circumferentially extending course direction and between 4 to 22 stitches per 2 cm, and more preferably between 9 to 15 stitches per 2 cm in a lengthwise extending wale direction.

The impervious coating 26, such as a silicone, silicone-based, liquid silicone rubber, polytetrafluoroethylene, or polyurethane coating, can be applied and bonded to the outer surface 13, with the coating 28 also referred to as layer, being bonded directly to the outer surface 13. The impervious layer 26 can be applied to the outer surface 13 using any desired process that allows the desired thickness (t) of the layer 26 to be attained. In the exemplary embodiment, the thickness t is between about 0.05 and 4 mm, and preferably between about 0.05 and 1.0 mm, and more preferably between about 0.1 and 0.3 mm. When the layer 26 is provided within the aforementioned range of thickness t, flexibility and conformability of the wall 12 remains, and optimal dielectric strength is provided, which can provide a dielectric breakdown voltage between about 5 to 40 kV. Accordingly, the elongate member 11 is protected against unwanted electrical interference, including electromagnetic interference (EMI), radiofrequency interference (RFI), and electrostatic discharge (ESD). In addition to the various electrical protections, greatly enhanced protection to the elongate member 11 against impact forces can be provided by the layer 26. Further yet, enhanced protection against the ingress of contamination is provided, such as to fluid gas and solid debris, given the layer 26 can be hydrophobic and impervious to fluid and debris.

In accordance with another aspect, a method of constructing a sleeve 10 is provided. The method includes knitting multifilament flame-resistant yarn having a denier between 30 tex to 420 tex to form a textile wall 12 having a circumferentially continuous outer surface 13 extending along a longitudinal axis 18 between opposite open ends 14, 16.

In accordance with another aspect of the invention, the method can further includes knitting the multifilament flame-resistant yarn using a rib-stitch pattern to form ribs R extending lengthwise along a longitudinal axis 18 of the sleeve 10, wherein the ribs R enhance the flame resistance of the wall 12, while at the same time enhancing the stretchability of the wall 12 in both the radial and axial directions.

In accordance with another aspect of the invention, the method further includes knitting the wall 12 entirely with flame-resistant multifilament yarn 22 having a denier between 100 tex to 180 tex, and in one exemplary embodiment, between 120 tex and 160 tex.

In accordance with another aspect of the invention, the method further includes knitting the stitch size having between 4 to 20 stitches per 2 cm, and more preferably between 10 to 17 stitches per 2 cm in the course direction, and between 4 to 22 stitches per 2 cm, and more preferably between 9 to 15 stitches per 2 cm in the wale direction.

In accordance with another aspect of the invention, the method can further include bonding an impervious coating 26 to the outer surface 13 of the textile wall 12, wherein the impervious coating 26 is formed of an elastomeric material to enhance the stretchability and resilience of the sleeve 10.

In accordance with another aspect of the invention, the method can further include forming the impervious coating 26 with an elastomeric, stretchable silicone, silicone-based, liquid silicone rubber, polytetrafluoroethylene, or polyurethane material.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A sleeve for protecting an elongate member, comprising:
a knit wall having a circumferentially continuous outer surface extending along a longitudinal axis between opposite open ends, said knit wall being formed at least in part by multifilament flame-resistant yarn having a denier between 30 tex to 420 tex; and
an impervious, elastomeric coating extending about said outer surface of said knit wall.

2. The sleeve of claim 1, wherein said knit wall is formed entirely by the multifilament flame-resistant yarn having a denier between 30 tex to 420 tex.

3. The sleeve of claim 2, wherein said knit wall is formed entirely by multifilament flame-resistant yarn having a denier between 100 tex to 180 tex.

4. The sleeve of claim 3, wherein said knit wall is formed entirely by multifilament flame-resistant yarn having a denier between 120 tex to 160 tex.

5. The sleeve of claim 1, wherein said impervious, elastomeric coating is one of a silicone, silicone-based, liquid silicone rubber, polytetrafluoroethylene, or polyurethane layer bonded directly to said outer surface.

6. The sleeve of claim 5, wherein said impervious, elastomeric coating has a thickness between about 0.05 and 4.0 mm.

7. The sleeve of claim 2, wherein said multifilament flame-resistant yarn is a mineral yarn.

8. The sleeve of claim 7, wherein said mineral yarn is at least one of fiberglass, silica, and basalt.

9. The sleeve of claim 2, wherein said multifilament flame-resistant yarn is knit having a stitch size between 4 to 20 stitches per 2 cm in a circumferentially extending course direction and between 4 to 22 stitches per 2 cm in a lengthwise extending wale direction.

10. The sleeve of claim 9, wherein said multifilament flame-resistant yarn is knit having a stitch size between 10 to 17 stitches per 2 cm in a circumferentially extending course direction and between 9 to 15 stitches per 2 cm in a lengthwise extending wale direction.

11. The sleeve of claim 1, wherein said multifilament flame-resistant yarn is knit to form lengthwise extending ribs and/or circumferentially extending ribs.

12. The sleeve of claim 11, wherein said plurality of ribs are formed via alternating knit and purl stitches with one another in a desired pattern

13. A sleeve for protecting a bus bar connection between cells of a battery pack of an electric vehicle, consisting of:
a knit wall having a circumferentially continuous outer surface extending along a longitudinal axis between opposite open ends, said knit wall being formed by multifilament flame-resistant yarn having a denier between 30 tex to 420 tex; and
an impervious, elastomeric coating extending about said outer surface of said knit wall.

14. The sleeve of claim 13, wherein said knit wall is formed by multifilament flame-resistant yarn having a denier between 100 tex to 180 tex.

15. The sleeve of claim 14, wherein said knit wall is formed by multifilament flame-resistant yarn having a denier between 120 tex to 160 tex.

16. The sleeve of claim 14, wherein said multifilament flame-resistant yarn is knit having a stitch size between 4 to 20 stitches per 2 cm in a circumferentially extending course direction and between 4 to 22 stitches per 2 cm in a lengthwise extending wale direction.

17. The sleeve of claim 16, wherein said multifilament flame-resistant yarn is knit having a stitch size between 10 to 17 stitches per 2 cm in a circumferentially extending course direction and between 9 to 15 stitches per 2 cm in a lengthwise extending wale direction.

18. The sleeve of claim 13, wherein said impervious, elastomeric coating is silicone-based.

19. A method of constructing a sleeve for providing dielectric protection to a bus bar interconnecting cells of a battery pack of an electric vehicle, comprising:
knitting multifilament flame-resistant yarn having a denier between 30 tex to 420 tex to form a textile wall having a circumferentially continuous outer surface extending along a longitudinal axis between opposite open ends; and
bonding an impervious, elastomeric coating to the outer surface of the textile wall.

20. The method of claim 19, further including knitting the multifilament flame-resistant yarn having a stitch size between 4 to 20 stitches per 2 cm in a circumferentially extending course direction and between 4 to 22 stitches per 2 cm in a lengthwise extending wale direction.
